(19) United States
(12) Patent Application Publication
(10) Pub. No.: US 2026/0288965 A1
(43) Pub. Date: Sep. 24, 2026

(54) MANAGING A FIRMWARE UPDATE EVENT FOR A DATA PROCESSING SYSTEM USING OUT OF BAND METHODS

(71) Applicant: Dell Products L.P., Round Rock, TX (US)

(72) Inventors: PHANINDRA BHARGAV TALASILA, Georgetown, TX (US); XIAOMEI ZHU MILLER, Round Rock, TX (US); ADOLFO SANDOR MONTERO, Pflugerville, TX (US); IBRAHIM SAYYED, Georgetown, TX (US)

(21) Appl. No.: 19/085,673

(22) Filed: Mar. 20, 2025

(51) Int. Cl. G06F 21/57; G06F 8/61; G06F 8/65

(52) U.S. Cl. CPC G06F 21/572; G06F 8/61; G06F 8/65

(57) ABSTRACT

Methods and systems for managing operation of data processing system are disclosed. To manage the data processing system, a management controller of the data processing system may attempt to verify integrity of a firmware image for a hardware component based on identification an occurrence of a firmware update event for the hardware of the data processing system. If the attempt to verify the firmware image is successful, the management controller may store the firmware image in a boot partition of a storage component hosted by the data processing system. The firmware image may be used to initiate an update of the hardware component to obtain an updated in-band components. The updated in-band components may be used in provisioning of the desired computer implemented services.

### FIELD

Embodiments disclosed herein relate generally to managing a data processing system. More particularly, embodiments disclosed herein relate to systems and methods for managing operation of data processing systems including sound systems using a management controller of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a second block diagram illustrating a data processing system in accordance with an embodiment.

FIG. 1C shows a third block diagram illustrating a data processing system in accordance with an embodiment.

FIGS. 2A-2C show interaction diagrams in accordance with an embodiment.

FIG. 3 shows a flow diagram illustrating a method of managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing systems may provide computer-implemented services to any type and number of other devices and/or users of the data processing systems. The computer-implemented services may include any quantity and type of such services.

To provide the computer-implemented services, a data processing system may perform a booting process to initialize operation of hardware resources hosted by the data processing system. To do so, a processor (e.g., a central programming unit (CPU)) of the hardware resources may utilize boot data (e.g., basic input/output system (BIOS) firmware, system configuration files, etc.) that may be stored on a boot storage device. The boot storage device may include, for example, a non-volatile memory storage device (e.g., serial peripheral interface flash).

However, a firmware update event may occur when an update to firmware for a hardware component of the hardware resources is identified. The firmware update event may include identifying update to software used to control and/or operate a hardware component hosted by a data processing system. The update may include obtaining and storing a new firmware image (e.g., updated configuration files, security features, bootloader, etc.) to a storage component (or otherwise herein referred to as storage device) hosted by the data processing system. The storage device may include a non-volatile memory (NVMe) storage device that may include a boot partition (e.g., a section of the storage device allocated to store data relevant to the booting process). For example, the processor may be unable to perform the booting process when a copy of the firmware image hosted by the boot storage device and/or boot partition of the storage device includes erroneous data (e.g., corrupted firmware, malicious data, incompatible firmware version, etc.), a firmware image is improperly flashed on the boot storage device, and/or any other causes impacting an ability of the processor to perform the booting process. Consequently, at least a portion of the hardware resources may be inoperable.

To modify operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during the booting process and/or regardless of an outcome of the booting process performed by booting components (e.g., the boot storage device and/or the processor) of the hardware resources.

Thus, to improve a likelihood that the data processing system may update the in-band components to provide the desired computer implemented services, the management controller may obtain a firmware image from a remote entity, and/or via other methods. The management controller may use the firmware image to perform an integrity verification process to identify whether the firmware image is trustworthy (e.g., is not corrupted). The firmware image include firmware files, configurations, etc. usable to update the hardware component the data processing system into a desired operating state (e.g., via the processor performing a successful boot of the data processing system).

The management controller may provide and/or obtain (e.g., read and/or write) the firmware image from the boot partition using a second side band communication channel. For example, the management controller may store an updated copy of the firmware image to the boot partition of the storage device and/or perform any other actions.

Once obtained, the firmware image may be used by the management controller to initiate updates to the hardware component of the hardware resources and subsequently initiate a new boot process to place the data processing system in a desired operating state (e.g., successfully perform a boot of the data processing system).

Thus, embodiments disclosed herein may provide an improved method for managing operation of a data processing system by using a management controller to obtain (e.g., from a remote entity) and store a firmware image in a boot partition of a storage device based on identifying that a firmware update event has occurred. By doing so, updates to the hardware components (e.g., for which the firmware image is to be applied) may be initiated to obtain updated in-band components used to provision desired computer-implemented services provided by the data processing system.

In an embodiment, a method for managing operation of a data processing system is provided. The method may include: making an identification of an occurrence of a firmware update event for a hardware component of hardware resources of the data processing system, the hardware resources being in-band components used in provisioning of desired computer implemented services; based on the identification: attempting to verify, using an out of band component of the data processing system, integrity of a firmware image for the hardware component; in a first instance of the attempting where the firmware image is verified: storing, by the out of band component, the firmware image in a boot partition of a storage component of the hardware resources, the boot partition being unusable by the in-band components; initiating, by the out of band component, updating of the hardware component using the firmware image in the boot partition to obtain updated in-band components; and provisioning the desired computer implemented services using the updated in-band components.

Attempting to verify the integrity of the firmware image may include: obtaining, by the out of band component and via an out of band channel, integrity verification data for the firmware image from a trusted source; attempting, by the out of band component, to cryptographically verify the firmware image using the integrity data; and in an instance of the attempting where the firmware image is verified: concluding that the firmware image is trustworthy for use in updating operation of the hardware component.

Storing the firmware image may include: providing, by the out of band component and via a sideband communication channel and based on the concluding that the firmware image is trustworthy, a copy of the firmware image to the storage component.

Storing the firmware image may further include: selectively powering the storage component while other hardware components of the hardware resources are depowered.

The firmware image may be stored in the storage component while a startup management entity is not operating.

Initiating the updating may include: instructing the startup management entity to install the firmware in the boot partition to the hardware component during a next startup of the data processing system.

The boot partition may be unusable by the in-band components while the startup management entity is not operating.

The boot partition may be usable by the in-band components while the startup management entity is operating.

Installing the firmware in the hardware component updates at least a portion of a manner of operation of the hardware component.

The out of band component may be a management controller operating independently from the in-band components of the data processing system.

The hardware resources may include a processor, a boot storage device, and the storage device, wherein the hardware resources are connected via at least one in-band channel.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

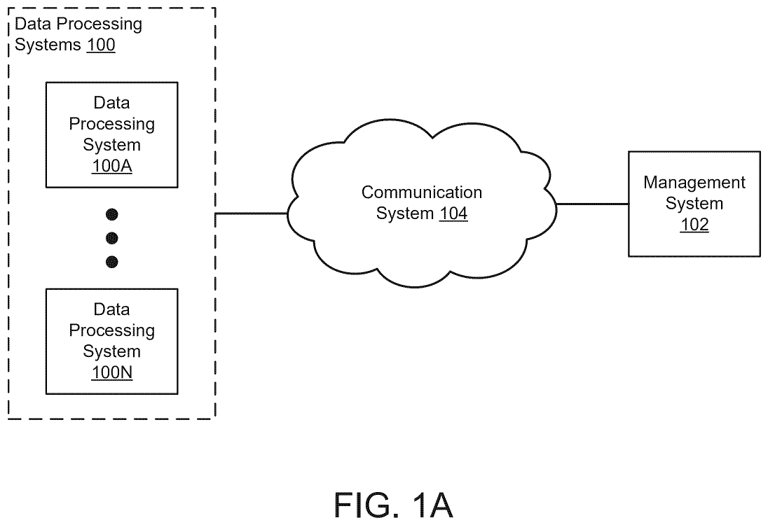

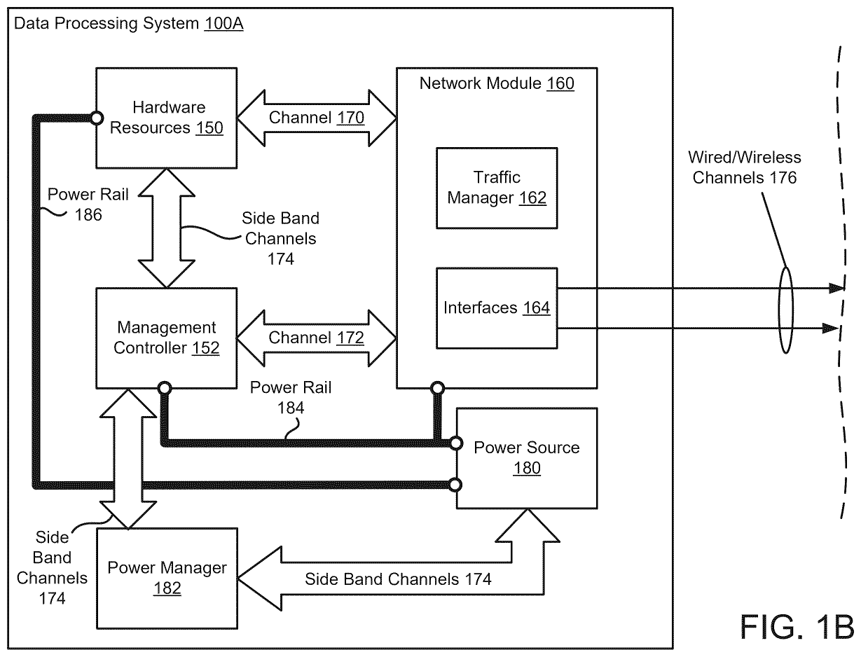

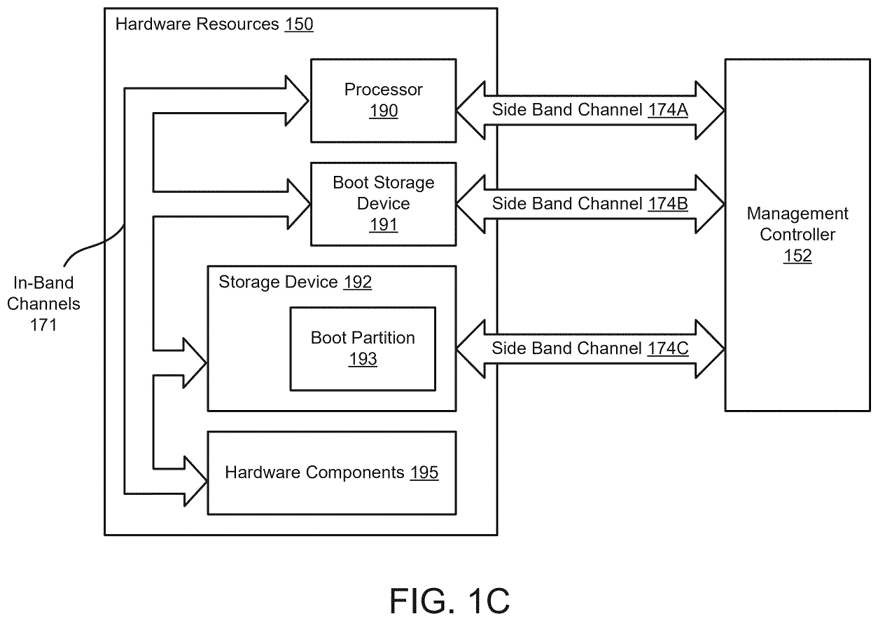

Turning to FIG. 1A, a block diagram illustrating a system in accordance with an embodiment is shown. The system shown in FIG. 1A may provide for management of data processing systems that may provide, at least in part, computer-implemented services. The system may include any number of data processing systems 100 (e.g., computing devices) that may each include any number of hardware components (e.g., processors, memory modules, storage devices, communications devices). The hardware components may support execution of any number and types of applications (e.g., software components). Changes in available functionalities of the hardware and/or software components may provide for various types of different computer-implemented services to be provided over time.

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by hardware resources of data processing systems 100. To provide the computer-implemented services, a data processing system may perform a booting process to initialize operation of the hardware resources. To do so, a processor (e.g., a central programming unit (CPU)) of the hardware resources may utilize boot data (e.g., basic input/output system (BIOS) firmware, system configuration files, etc.) that may be stored on a boot storage device. The boot storage device may include, for example, a non-volatile memory storage device (e.g., serial peripheral interface flash).

By performing the booting process, the hardware resources of the data processing system may be operably connected to each other (e.g., via in-band channels) and an operating system may be loaded to provide management functionality.

However, an unrecoverable boot failure may occur when the processor is unable to perform the booting process using a verified recovery image stored on the boot storage device and/or a boot partition of the storage device. For example, the processor may be unable to perform the booting process when the firmware images hosted by the boot storage device and/or the boot partition of the storage device includes erroneous data (e.g., corrupted firmware, malicious data, incompatible firmware version, etc.), a firmware image is improperly flashed on the boot storage device and/or boot partition of the storage device, and/or any other causes impacting an ability of the processor to perform the boot of the data processing system. Consequently, at least a portion of the hardware resources may be inoperable.

To modify operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during the booting process and/or regardless of an outcome of the booting process performed by booting components (e.g., the boot storage device and/or the processor) of the hardware resources.

In general, embodiments disclosed herein relate to systems, devices, and methods for managing operation of a data processing system. To manage the operation of a data processing system, the management controller may obtain and attempt to verify integrity of a firmware image for a hardware component hosted by hardware resources of the data processing system in the event that a firmware update event for the hardware component is identified. If the attempt to verify the integrity of the firmware image is successful (e.g., the firmware image is concluded to be trustworthy), the management controller may store the firmware image in a boot partition of a storage device hosted by the data processing system.

Thus, to improve a likelihood that the data processing system may update the in-band components to provide the desired computer implemented services, the management controller may obtain a firmware image from a remote entity. The firmware image include firmware files, configurations, etc. usable to update operation of the hardware component the data processing system to place the in-band components of the data processing system into a desired operating state (e.g., via the processor performing a successful new boot of the data processing system using the firmware image).

The management controller may provide and/or obtain (e.g., read and/or write) data from the boot partition using a second side band communication channel. For example, the management controller may store an updated copy of the firmware image to the boot partition of the storage device and/or perform any other actions.

Once obtained, the firmware image may be used by the processor of the hardware resources to subsequently initiate a new boot process to place the data processing system in a desired operating state (e.g., successfully perform a boot of the data processing system).

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band communication channel.

While providing the at least a portion of the computer-implemented services, a data processing system (e.g., 100A) of data processing systems 100 may communicate with and/or obtain information from management system 102. For example, data processing system 100A may obtain instructions relevant to updated boot software (e.g., an updated firmware version), implementing a boot software recovery policy, management requests to modify operation of the hardware resources (e.g., installing new applications), and/or any other information. Data processing system 100A may subsequently perform actions based on the information obtained from management system 102 to update operation of data processing system 100A.

Management system 102 may, as discussed above, provide remote management services. Management system 102 may include, for example, a second data processing system operated an owner of data processing systems 100. To provide the remote management services, management system 102 may interact with data processing systems 100 to obtain and/or provide information (e.g., data) relevant to operation of data processing systems 100. For example, management system 102 may generate and provide a firmware image to a data processing system of data processing systems 100 for use in storing an updated firmware image in a boot partition, restoring boot data hosted on a boot storage device of the data processing system, and/or any other purposes.

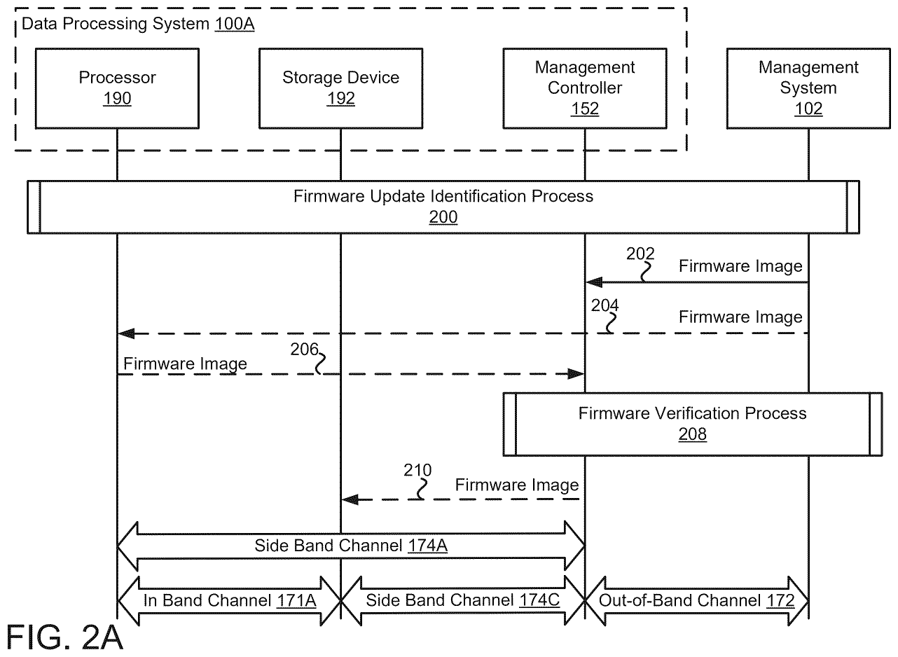

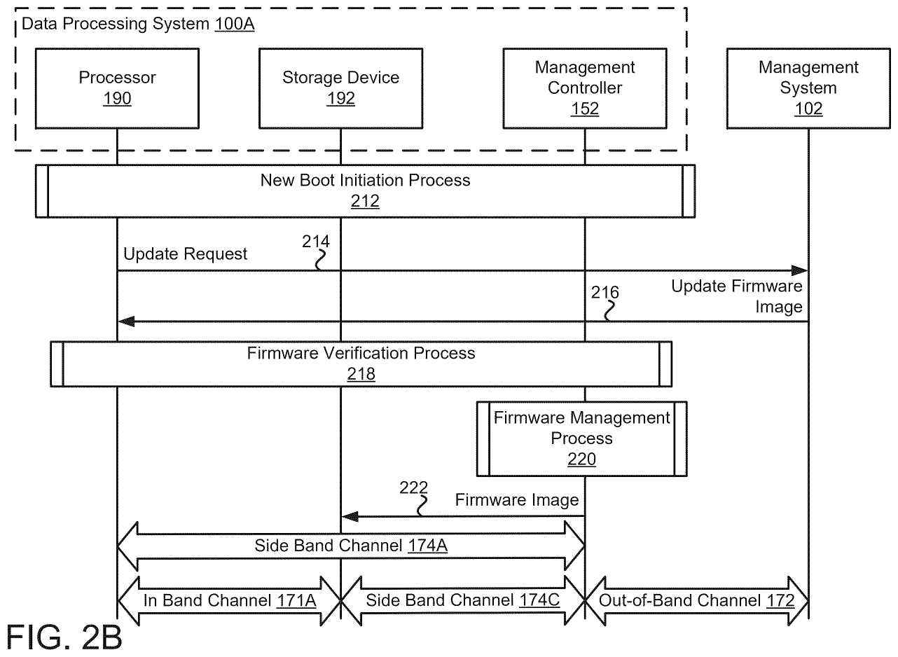

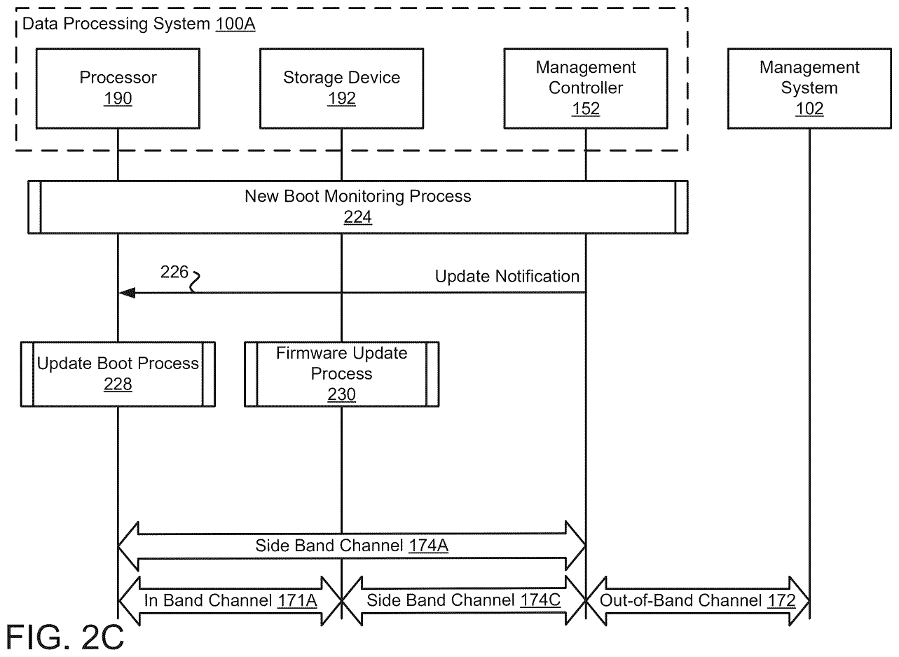

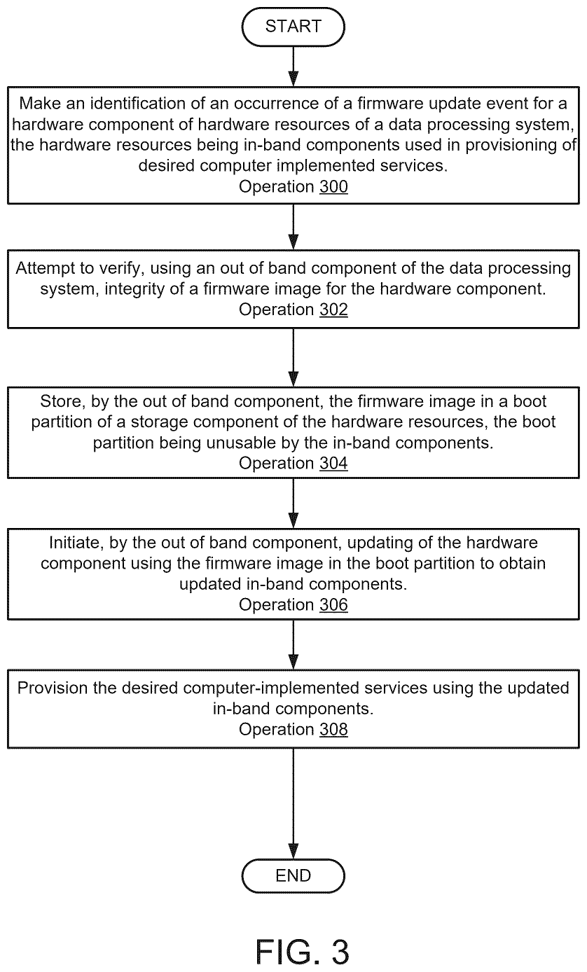

While providing their functionality, any of data processing systems 100, and management system 102 may provide all or a portion of the methods shown in FIGS. 2A-3.

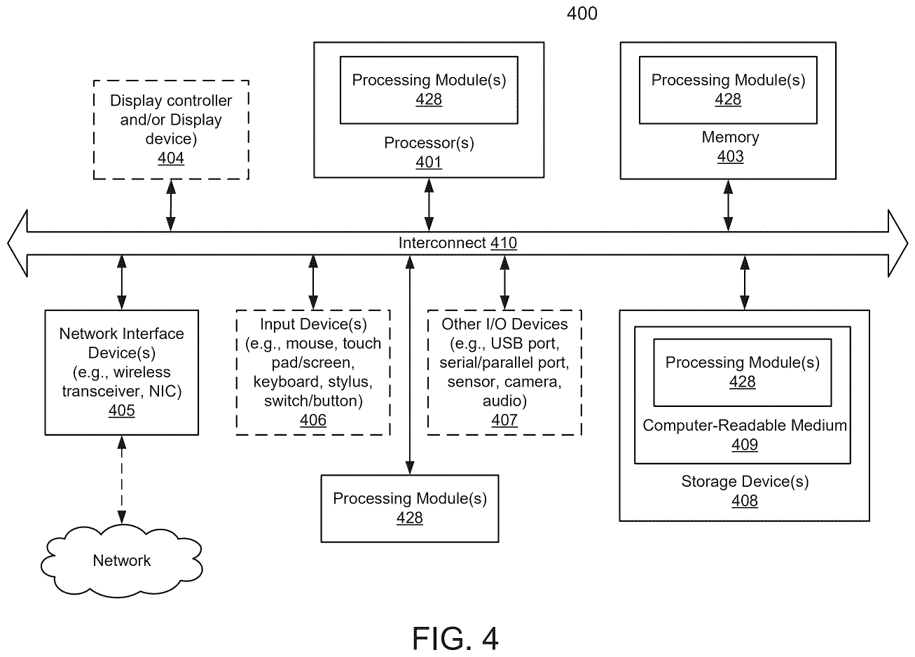

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by obtaining and storing a recovery image to a boot partition of a storage device hosted by hardware resources of the data processing system when an unrecoverable boot failure is identified by a management controller of the data processing system. By doing so, the data processing system may be rebooted using the recovery image to place the data processing system in desired operating state.

While providing their functionality, any of data processing systems 100, and management system 102 may provide all or a portion of the methods shown in FIGS. 2A-3.

Any of the components illustrated in FIG. 1A may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and/or types of communication protocols (e.g., such as the internet protocol). Communication system 104 may include any number of in-band communication channel and/or out-of-band communication channels.

While illustrated in FIG. 1A as including a limited number of specific components, a system in accordance with an embodiment may include fewer, additional, and/or different components than those illustrated therein. For example, while the system of FIG. 1A shows a single management system (e.g., 102), it will be appreciated that the system may include any number of management systems.

Turning to FIG. 1B, a diagram illustrating data processing system 100A in accordance with an embodiment is shown. Data processing system 100A may be similar to any of data processing systems 100A-100N shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components. Hardware resources 150 may (e.g., via the processor) provide the computer-implemented services desired by users of data processing system 100.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100) to another device via any number of intermediate networks (e.g., via wired/wireless channels 176 that are part of the networks).

In addition, different configurations of hardware resources 150 and/or software resources may be implemented by data processing system 100 based on the type of computer-implemented services that are to be provided. Modifications to configurations of hardware resources 150 and/or the software resources may lead to downtime for data processing system 100 and may consume network bandwidth of channel 170.

To reduce the likelihood of the applications and/or other in-band entities from being indirectly compromised, data processing system 100 may include management controller 152 and network module 160. Each of these components of data processing system 100 is discussed below.

Management controller 152 may operate independently from hardware resources 150 and, therefore, hardware resources 150 may not host and/or manage operation of management controller 152. In addition, management controller 152 may be distinct from hardware resources 150 and, therefore, may be physically separate from hardware resources 150. Management controller 152 may also be operably connected to communication components of data processing system 100 via separate channels (e.g., 172) from the in-band components.

Management controller 152 may be implemented, for example, using a system on a chip or other type of independently operating computing device (e.g., independent from the in-band components, such as hardware resources 150, of a host data processing system 100). Management controller 152 may provide various management functionalities for data processing system 100. For example, management controller 152 may monitor various ongoing processes performed by the in-band component, may manage power distribution, thermal management, and/or other functions of data processing system 100A.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

Information provided to the application by management controller 152 may include, for example, instructions for implementation of computer-implemented services desired by users of data processing system 100.

To facilitate communication with other devices, data processing system 100 may include network module 160. Network module 160 may provide communication services for in-band components and out-of-band components (e.g., management controller 152) of data processing system.

To provide the above-described functionalities, network module 160 may include traffic manager 162, interfaces 164, and may host an instance of a TCP/IP stack to facilitate communication with other devices independently of any of the in-band components (e.g., does not rely on any hosted software, hardware components, etc.). Accordingly, compromise of any of hardware resources 150 and hosted component may not result in indirect compromise of network module 160, management controller 152, and entities hosted by management controller 152.

Management controller 152 may be operably connected to communication components of data processing system 100 via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100 may include network module 160. Network module 160 may provide communication services for in-band components and out-of-band components (e.g., management controller 152) of data processing system 100. To do so, network module 160 may include traffic manager 162 and interfaces 164.

Traffic manager 162 may include functionality to (i) discriminate traffic directed to various network endpoints advertised by data processing system 100, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100 may appear to be two independent network entities, that may independently addressable, and otherwise unrelated to one another.

Network module 160 may utilize the instance of the TCP/IP stack to allow hardware resources 150 and/or management controller 152 to communicate with other devices via packet switched networks and/or other types of communication networks.

To facilitate management of data processing system 100 over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100 may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails (e.g., by providing instructions via side band channels 174). Management controller 152 may cooperate with power manager 182 to manage supply of power to these power domains. Management controller 152 may communicate with power manager 182 via side band channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations described in FIG. 2A.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, and storage device 192. For example, to place a data processing system (e.g., 100A) in a desired operating state, data processing system 100A may perform a booting process to initialize hardware resources and facilitate operation of an operating system. To do so, processor 190 may execute instructions indicated by boot data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store information, such as firmware, an image of a management entity (BIOS, universal extensible firmware interface (UEFI), etc.), system configuration files, and/or any other information usable to boot data processing system 100A. Because boot storage device 191 may have a limited storage capacity, storage device 192 may be used to store additional information (e.g., other copies of boot data).

Storage device 192 may include, for example, a second storage device such as a non-volatile memory express (NVMe) based solid-state drive. Storage device 192 may include a boot partition (193) that may be configured to store data usable to boot data processing system 100A (e.g., a latest stable copy of boot data, bootloader files, configuration files, etc.). Boot partition 193 may include an allocated section of storage device 192 that may, for example, be isolated from other memory sections of storage device 192.

Processor 190 may include a central processing unit (CPU) that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

However, at least a portion of in-band channels 171 may not be functional and/or may have reduced functionality during booting of data processing system 100A and/or as a result of an undesired boot event. For example, in an event that storage device 192 and/or hardware components 195 are not initialized during booting, processor 190 may not be able to communicate with storage device 192 to obtain a copy of boot data (e.g., a backup copy, a recovery file, etc.) for use in rebooting and placing data processing system 100A in a desired operating state.

Thus, to improve a likelihood that data processing system 100A may be booted and placed in the desired operating state, management controller 152 may perform management functionalities using any number and/or type of side band channels (e.g. 174). For example, management controller may obtain information (e.g., telemetry data, process results, boot times, etc.) regarding a boot status from processor 190 using side band channel 174A, replace a copy of undesired boot data hosted by boot storage device 191 with a latest stable copy of boot data using side band channel 174B, read and/or write boot data to boot partition 193 of storage device 192 using side band channel 174C, and/or perform any other actions by communicating with components of hardware resources regardless of a boot status of data processing system 100A.

To further clarify embodiments disclosed herein, interaction diagrams in accordance with an embodiment are shown in FIGS. 2A-2C. The interaction diagrams may illustrate how data may be obtained and used within the system of FIGS. 1A-1C.

In the interaction diagram, processes performed by and interactions between components of a system in accordance with an embodiment are shown. In the diagram, components of the system are illustrated using a first set of shapes (e.g., 190, 191, etc.), located towards the top of each figure. Lines descend from these shapes. Processes performed by the components of the system are illustrated using a second set of shapes (e.g., 200, 210, etc.) superimposed over these lines.

Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 206. However, it will be appreciated that the processes and interactions may be performed in different orders, any may be omitted, and other processes or interactions may be performed without departing from embodiments disclosed herein.

The processes shown in FIG. 2A may be performed by any entity shown in the systems of FIGS. 1A-1C (e.g., a device similar to data processing system 100A, a device similar to management system 102, etc.) and/or another entity without departing from embodiments disclosed herein.

Turning to FIG. 2A, a first interaction diagram in accordance with an embodiment is shown. The interaction diagram may illustrate processes and interactions that may occur during managing firmware data using out of band components when an occurrence of a firmware update event is identified for a hardware component of a data processing system.

To identify that a firmware update event has occurred, firmware update identification process 200 may be performed. During firmware update identification process 200, a new and/or updated firmware image for a hardware component may be identified as being available via various methods. For example, an out of band component (e.g., management controller 152) may (i) provide a request to a trusted source (e.g., management system 102) hosting any available firmware images for data processing system 100A, (ii) receive an updated firmware image in response to the request, (iii) receive an unsolicited updated firmware image from management system 102, and/or (iv) by any other methods.

For example, at interaction 202, a firmware image may be provided to management controller 152 by management system 102. The firmware image may include, for example, a copy of an image of firmware, configuration files, and/or any other information. The contents of the firmware image may vary based on the device type, manufacturer, etc. The firmware image (e.g., configuration files, device drivers, bootloader, etc.) may be used for managing a hardware component (e.g., storage devices, graphics processing unit (GPU), peripheral devices, etc.) of the hardware resources of the data processing system (e.g., data processing system 100A). To obtain the firmware image, management controller 152 may receive the firmware image from a trusted source, for example, management system 102 via out-of-band communication channels (e.g., out-of-band channels 172). Once obtained, the firmware image may be stored, at least temporarily, by management controller 152.

As part of performing firmware update identification process 200, the firmware update for a hardware component may be identified via a driver (e.g., for the respective hardware component) hosted by processor 190. For example, during firmware update identification process 200, a device driver may send a request to a trusted source (e.g., management system 102) that hosts the firmware updates during startup of the data processing system, on a periodic schedule, etc. The trusted source (e.g., management system 102) may use the request (e.g., including verification data) to ensure the validity of the request and identify if a new firmware version is available for data processing system 100A.

Once identified and at interaction 204, the firmware image may be provided to processor 190 by management system 102. The firmware image may be provided, for example, by transmitting the firmware image to processor 190 (e.g., more specifically the device driver operating on the processor) via in-band interfaces, downloading the firmware image by the device driver, and/or via any other processes.

Once obtained and at interaction 206, the firmware image (and/or a copy of the firmware image) may be provided to management controller 152 from processor 190. For example, the firmware image may be provided by: (i) locating the firmware image, (ii) transferring the firmware image to management controller 152 via side band channel 174A and/or using a data transfer protocol (e.g., non-volatile memory express, universal serial bus, etc.), and/or via any other processes. Once obtained, the firmware image may be stored, at least temporarily, by management controller 152.

To verify the firmware image, firmware verification process 208 may be performed. During firmware verification process 208, a copy of the firmware image may be used by management controller 152 to verify an integrity of the firmware image (e.g., verify that the firmware image is not corrupted after download from the trusted source). For example, firmware verification process 208 may perform any type of verification processes using hash verification processes and/or other integrity checking processes. For example, management controller 152 may compute a hash of the downloaded firmware image and may compare it with a hash value provided by the trusted source (e.g., in the firmware metadata). If the computed hash of the downloaded firmware image matches the hash received from the trusted source (e.g., management system 102), the firmware image may be intact and management controller 152 may verify the firmware image to be trustworthy (e.g., useable in updating the respective hardware component). Refer to FIG. 2C for additional information regarding updating firmware of the data processing system.

Once the firmware image is verified and at interaction 210, the firmware image may be provided to storage device 192 by management controller 152. The firmware image may be stored in a boot partition (e.g., boot partition 193 shown in FIG. 1C) of storage device 192. To store the recovery data in the boot partition of storage device 192, management controller 152 may make a determination whether the boot partition of storage device 192 for storing the recovery data exists and if so, a request to write data to the boot partition (e.g., boot partition 193), address for the boot partition, and/or any other information may be provided to storage device 192.

If determined that the boot partition does not exist, management controller 152 may create the boot partition independently using a side band channel to storage device 192. For example, the boot partition (e.g., boot partition 193) may be created by management controller 152 using side band channel 174C in a manner that is independent of the cooperation with any management entities of hardware resources 150 of the data processing system.

To create the boot partition on storage device 192, a portion of storage resources of storage device 192 may be allocated for recovery data. For example, to allocate the portion of storage resources, a size of a partition (e.g., a logical partition) may be configured, the portion of storage resources may be formatted, and/or nay other actions may be performed to establish the boot partition. Once established, the boot partition (e.g., 193) may store the firmware image that may be isolated from other data stored on storage device 192.

Side band channels (e.g., 174A-174C) may be used to facilitate communication between management controller 152 and storage device 192, and are shown to indicate that management controller 152 may interface with processor 190, boot storage device 191, and storage device 192 regardless of a status of in-band channels (e.g., that may have reduced functionality due to the unrecoverable boot failure). Using the side band channels, management controller 152 may perform management commands that may include, for example, accessing secured data, providing instructions to use the data, obtaining information regarding an operating state of hardware resources 150, installing management entities on hardware resources 150 using the data, and/or performing any other actions.

Thus, using processes and interactions shown in FIG. 2A, a firmware image may be obtained and stored, using a management controller, in a boot partition of a storage device hosted by the data processing system. By doing so, the firmware image may be obtained, by a management controller, when an occurrence of a firmware update event is identified and used during performance of a new boot of the data processing system to place the data processing system in a desired operating state.

Turning to FIG. 2B, a second interaction diagram in accordance with an embodiment is shown. The interaction diagram may illustrate processes and interactions that may occur during identification of a firmware update event by a management entity hosted by hardware resources of a data processing system.

To identify the firmware update event, new boot initiation process 212 may be performed. During new boot initiation process 212, a booting process of a data processing system (e.g., data processing system 100A) may be initiated by processor 190. processor 190 may attempt to boot data processing system 100A using boot data hosted by boot storage device 191 (e.g., described above and shown in FIG. 1C), and management controller 152 may monitor the boot via a side band communication channel. For example, processor 190 may attempt to boot data processing system 100A by receiving a reset signal (e.g., via a power-on process), initializing registers, retrieving data (e.g., BIOS, UEFI, etc.) stored on boot storage device 191 via an in-band channel (e.g., in band channels 171 shown in FIG. 1C), attempting to execute instructions (e.g., firmware code) based on the data, and/or performing any other actions.

During new boot initiation process 212, processor 190 may attempt to boot data processing system 100A using boot data hosted by storage device 192 (e.g., described above and shown in FIG. 1C), and management controller 152 may monitor the boot via a side band communication channel. For example, processor 190 may attempt to boot data processing system 100A by receiving a reset signal (e.g., via a power-on process), initializing registers, retrieving data (e.g., BIOS, UEFI, etc.) stored on storage device 192 via an in-band channel 171A, attempting to execute instructions (e.g., firmware code) based on the data, and/or performing any other actions.

While attempting to boot, processor 190 may be operably connected to storage device 192 via in-band channel 171A but may not operably connected to boot storage device 191 (and/or any other hardware components). In-band channel 171A may include, for example, a limited communication channel between processor 190 and storage device 192 that may be facilitated using a signal multiplexer that may enable processor 190 to communicate with storage device 192 (e.g., using a system bus) while limiting communication with the other hardware components prior to a management entity (e.g., an operating system, drivers, etc.) being loaded as a result of a successful booting.

During new boot initiation process 212, data processing system 100A may be booted, and information regarding the booting may be obtained by management controller 152. For example, data processing system 100A may be booted by: (i) retrieving, by processor 190, the boot data (e.g., image of a management entity, system configuration files, etc.) from the boot partition of storage device 192, (ii) executing instructions indicated by the firmware image, (iii) initializing hardware resources (e.g., loading firmware-level drivers), (iv) validating a state of the hardware resources, (v) loading an operating system into memory, and/or via any other processes.

During new boot initiation process 212, processor 190 may initiate identification of updates to firmware data (e.g., firmware image, system configuration files, etc. for hardware components of the data processing system). To do so, a management entity (e.g., BIOS operating on processor 190) may generate a request to a trusted source to identify any updates to the firmware data.

At interaction 214, an update request may be provided to management system 102 by processor 190. The update request may include, for example, (i) a request if a new and/or update to firmware is available for any hardware components hosted by data processing system 100A, (ii) identifier for data processing system 100A (e.g., device model information), current firmware version, hardware identifiers (e.g., serial number, hardware version, etc.), and/or any other information necessary to identify a firmware update is available. The update request may be provided by (i) transmitting, by the management entity, the update request for the firmware image to management system 102 using a local network connection, (ii) transmitting the update request for the firmware image to management system 102 via in-band components, and/or (iii) via any other processes.

Once obtained, the update request may be used to initiate identification of the firmware image for the respective data processing system (e.g., data processing system 100A). To do so, management system 102 may perform any type of authentication process (e.g., to ensure the request is valid and from an authorized device allowed to query for updates), and identify firmware image updates for the respective data processing system.

Once identified and at interaction 216, update firmware image may be obtained by processor 190 from management system 102. The update firmware image may include, for example, a copy of a firmware image, firmware metadata (e.g., metadata about the available firmware update) and/or any other information for a hardware component of the hardware resources. For example, the update firmware image may include the new firmware version number, a digital signature for the firmware image (e.g., to ensure integrity and authenticity), the size of the firmware image, hash values (e.g., usable for checking the integrity of the firmware file), and/or any other information regarding the firmware update.

To obtain the update firmware image, processor 190 may receive the update firmware image from a remote entity, for example, management system 102 via a network connection. Once obtained, the update firmware image may be stored, at least temporarily, by processor 190 to a storage component (e.g., storage device 192) of data processing system 100A.

Once obtained, the update firmware image may be used to perform firmware verification process 218. During firmware verification process 218, the update firmware image may be used in any type of verification process to identify the integrity of the firmware image for the intended hardware component. Similar to performing firmware verification process 208 described and shown in FIG. 2A, an out of band component (e.g., management controller 152) may obtain verification data for the firmware image and attempt to perform a cryptographical verification process using the verification data to identify whether the firmware image is trustworthy for use in updating operation of the hardware component.

In an instance of performing the firmware verification process 218 where the firmware image is not verified, the firmware image may not be stored in the storage component of data processing system 100A. Consequently, the booting process may utilize the firmware image currently stored in the boot partition of storage device 192 to successfully boot data processing system 100A.

In performing the firmware verification process 218 where the firmware image is verified, the out of band component may conclude the firmware image is trustworthy for use in updating operation of the hardware component. Once the firmware image is verified, firmware management process 220 may be performed. During firmware management process 220, the out of band component may obtain a copy of the firmware image. To obtain the firmware image, management controller 152 may identify the location of the firmware image, transmit a request to access the firmware image via side band channel 174A, the firmware image may be transferred to management controller using a communication protocol (e.g., serial peripheral interface) that may be supported by processor 190, the firmware image may be transmitted based on an operating system configuration, and/or via any other processes. Once obtained, the firmware image may be stored, at least temporarily, by management controller 152.

At interaction 222, the firmware image may be provided to boot partition 193 of storage device 192 for storage. For example, the firmware image may be stored on the boot partition by (i) issuing, by management controller 152, a write request to storage device 192 via side band channel 174C, (ii) identifying, by storage device 192, a physical storage location (e.g., a flash memory cell) for the boot partition, (iii) writing the firmware image to the storage location, and/or performing any other actions.

Turning to FIG. 2C, a third interaction diagram in accordance with an embodiment is shown. The interaction diagram may illustrate processes and interactions that may occur during implementation of firmware update for a hardware component during a rebooting of a data processing system when a firmware update event is identified.

To implement a firmware update for a hardware component of data processing system 100A, new boot monitoring process 224 may be performed. During new boot monitoring process 224, data processing system 100A may be booted, and information regarding the booting may be obtained by management controller 152. For example, data processing system 100A may be booted by: (i) retrieving, by processor 190, the boot data (e.g., image of a management entity, system configuration files, etc.) from storage device 192, (ii) executing instructions indicated by the boot data, (iii) initializing hardware resources (e.g., loading firmware-level drivers), (iv) validating a state of the hardware resources, (v) loading an operating system into memory, and/or via any other processes.

During the booting, management controller 152 may obtain information (e.g., updates to data stored in boot partition, telemetry data, processing results, etc.) from processor 190 via side band channel 174A. Based on the information, management controller 152 may identify an update to the boot data (e.g., update to firmware image) stored in the boot partition of storage device 192 and may be used to apply updates to the respective hardware component during booting of data processing system 100A.

At interaction 226, an update notification may be provided to processor 190 by management controller 152. For example, the update notification may be provided to processor 190 by: (i) transferring the update notification to processor 190 via side band channel 174A and/or using a data transfer protocol (e.g., non-volatile memory express, universal serial bus, etc.), and/or via any other processes. The update notification may include a message indicating that an update to the firmware image for a hardware component of the data processing system has been identified and to initiate an update of the firmware (e.g., perform an firmware installation process) as part of the booting process. Refer to FIGS. 2A-2B for additional information regarding obtaining the (updated) firmware image.

Once obtained, an update boot process 228 may be performed to attempt to boot data processing system 100A using the backup image. Update boot process 228 may be initiated by processor 190, as a result of a configuration (e.g., based on an update to storage resources hosted by storage device 192), and/or via any other mechanisms. During update boot process 228, processor 190 may retrieve the firmware image from the boot partition of storage device 192, execute instructions (e.g., firmware code) based on the firmware image, initialize hardware resources, and provide control to a management entity.

To initiate updating of the hardware component, firmware update process 230 may be performed. During firmware update process 230 may include using the firmware image to update the firmware for the respective hardware component (e.g., storage device 192). For example, the new firmware image may be loaded into memory of storage device 192, and apply the update to the firmware. The updates may include new features, security patches, etc.

By executing the instructions based on the firmware image, processor 190 may perform operations that may place data processing system 100A in a desired state (e.g., completion of the boot of the hardware resources of data processing system 100A). For example, software and/or hardware resources may be validated (e.g., during a power on self-test), the hardware resources may be configured and/or initialized, an operating system may be loaded to memory of data processing system 100A (e.g., using a bootloader), and/or any other actions may be performed.

Thus, using processes and interactions shown in FIG. 2C, a firmware image may be verified using out of band component of a data processing system and used to update the hardware component during a boot of a data processing system in the event an occurrence of a firmware update for the hardware component is identified. By doing so, the data processing system may be places in a desired operating state for providing computer-implemented services.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIG. 3 illustrate a method that may be performed by the components of the system of FIGS. 1A-1C. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by a data processing system, a management system, a communication system, a management controller, hardware resources, and/or other components illustrated in FIGS. 1A-2C.

At operation 300, an occurrence of a firmware update event for a hardware component of hardware resources of a data processing system may be identified. The hardware resources may be in-band components used in provisioning of desired computer implemented services. The occurrence of the firmware update event may be identified by (i) receiving an update from a trusted source (e.g., management system 102) hosting updates to firmware for the hardware components of the data processing system, (ii) receiving, by a management entity of the data processing system, an update from the trusted source, (iii) monitoring, by the out of band component, updates received by in-band components of the data processing system, and/or (iv) by any other methods.

At operation 302, verifying integrity of a firmware image for the hardware component may be attempted using an out of band component of the data processing system. Attempting to verify the integrity of the firmware image may include: (i) obtaining, by the out of band component and via an out of band channel, integrity verification data for the firmware image from a trusted source, (ii) attempting, by the out of band component, to cryptographically verify the firmware image using the integrity data, (iii) in an instance of the attempting where the firmware image is verified: concluding that the firmware image is trustworthy for use in updating operation of the hardware component, and/or (iv) performing any other methods.

Obtaining the integrity verification data for the firmware image from the trusted source may be obtained by (i) requesting, by the out of band component (e.g., management controller 152) and using the out of band channel (e.g., out of band channel 172), (ii) receiving, by the out of band component from the trusted source, the integrity verification data, and/or (iii) by any other methods.

Attempting to cryptographically verify the firmware image may include (i) performing a matching process using the integrity verification data, (ii) based on the matching process identifying no changes to the firmware image from the integrity verification data, and/or (iii) by any other methods.

Concluding that the firmware image is trustworthy for use in updating operation of the hardware component may include identifying that the firmware image (e.g., downloaded from the trusted source) was obtained by the trusted source and has not been modified.

In a first instance of the attempting where the firmware image is verified, the operation may proceed to operation 304. In a second instance of the attempting where the firmware image is not verified (e.g., the firmware image is not trustworthy), the firmware image may not be used in performing the updating of the hardware component.

At operation 304, the firmware image may be stored by the out of band component in a boot partition of a storage component of the hardware resources. The boot partition may be unusable by the in-band components. Storing the firmware image may include: (i) providing, by the out of band component and via a sideband communication channel and based on the concluding that the firmware image is trustworthy, a copy of the firmware image to the storage component, (ii) selectively powering the storage component while other hardware components of the hardware resources are depowered, and/or (iii) performing other methods.

For example, storing the firmware image may include: (i) identifying whether a boot partition exists on the storage component, (ii) cooperatively, between the management controller and the storage component, allocating a portion of storage resources of the storage component to create the boot partition in an instance where the boot partition does not exist, (iii) issuing, by the out of band component, a write request to the storage component to store the firmware image to the boot partition, and/or (iv) by any other processes.

At operation 306, updating of the hardware component may be initiated using the firmware image in the boot partition to obtain updated in-band components. Initiating updating of the hardware component may include instructing the startup management entity to install the firmware in the boot partition to the hardware component during a next startup of the data processing system and initiating a new boot of the data processing system.

The new boot may be initiated by a processor of the hardware resources and using an in band channel between the processor and the storage device. The new boot may be initiated by: (i) sending a reset signal to the processor (e.g., by the management controller), (ii) triggering a new boot based on an update to the storage device, (iii) executing instructions indicated by the firmware image, (iv) loading an operating system into memory of the data processing system, and/or performing any other actions to place the data processing system in a desired operating state.

At operation 308, the desired computer-implemented services may be provisioned using the updated in-band components. The desired computer-implemented services may be provisioned by: (i) installing a new management entity (e.g., an application, driver, firmware etc.), (ii) providing an interface for a user of the data processing system, and/or via any other processes.

The method may end following operation 308.

Using the method shown in FIG. 3, operation of a data processing system may be managed using a management controller to obtain and to verify an updated firmware image when an occurrence of an firmware update event for a hardware component of the data processing system is identified. The management controller may use side band channels to perform monitor the booting of the data processing system, obtain the firmware image from a remote entity via out-of-band communication methods and/or store the firmware image in a boot partition of the storage device. By doing so, a processor hosted by the hardware resources may initiate a new boot using the firmware image to boot the data processing system into a desired operating state.

Any of the components illustrated in FIGS. 1A-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations.

System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of a data processing system, the method comprising:
making an identification of an occurrence of a firmware update event for a hardware component of hardware resources of the data processing system, the hardware resources being in-band components used in provisioning of desired computer implemented services;
based on the identification:
attempting to verify, using an out of band component of the data processing system, integrity of a firmware image for the hardware component;
in a first instance of the attempting where the firmware image is verified:
storing, by the out of band component, the firmware image in a boot partition of a storage component of the hardware resources, the boot partition being unusable by the in-band components;
initiating, by the out of band component, updating of the hardware component using the firmware image in the boot partition to obtain updated in-band components; and
provisioning the desired computer implemented services using the updated in-band components.

2. The method of claim 1, wherein attempting to verify the integrity of the firmware image comprises:
obtaining, by the out of band component and via an out of band channel, integrity verification data for the firmware image from a trusted source;
attempting, by the out of band component, to cryptographically verify the firmware image using the integrity data; and
in an instance of the attempting where the firmware image is verified:
concluding that the firmware image is trustworthy for use in updating operation of the hardware component.

3. The method of claim 2, wherein storing the firmware image comprises:
providing, by the out of band component and via a sideband communication channel and based on the concluding that the firmware image is trustworthy, a copy of the firmware image to the storage component.

4. The method of claim 3, wherein storing the firmware image further comprises:
selectively powering the storage component while other hardware components of the hardware resources are depowered.

5. The method of claim 3, wherein the firmware image is stored in the storage component while a startup management entity is not operating.

6. The method of claim 5, wherein initiating the updating comprises:
instructing the startup management entity to install the firmware in the boot partition to the hardware component during a next startup of the data processing system.

7. The method of claim 6, wherein the boot partition is unusable by the in-band components while the startup management entity is not operating.

8. The method of claim 7, wherein the boot partition is usable by the in-band components while the startup management entity is operating.

9. The method of claim 6, wherein installing the firmware in the hardware component updates at least a portion of a manner of operation of the hardware component.

10. The method of claim 1, wherein the out of band component is a management controller is independently operational from the hardware resources while connected to the hardware resources via side-band channels during the boot of the data processing system.

11. A non-transitory machine-readable medium having instructions stored therein, which when executed by a processor, cause the processor to perform operations for managing operation of a data processing system, the operations comprising:
making an identification of an occurrence of a firmware update event for a hardware component of hardware resources of the data processing system, the hardware resources being in-band components used in provisioning of desired computer implemented services;
based on the identification:
attempting to verify, using an out of band component of the data processing system, integrity of a firmware image for the hardware component;
in a first instance of the attempting where the firmware image is verified:
storing, by the out of band component, the firmware image in a boot partition of a storage component of the hardware resources, the boot partition being unusable by the in-band components;
initiating, by the out of band component, updating of the hardware component using the firmware image in the boot partition to obtain updated in-band components; and
provisioning the desired computer implemented services using the updated in-band components.

12. The non-transitory machine-readable medium of claim 11, wherein attempting to verify the integrity of the firmware image comprises:
obtaining, by the out of band component and via an out of band channel, integrity verification data for the firmware image from a trusted source;
attempting, by the out of band component, to cryptographically verify the firmware image using the integrity data; and
in an instance of the attempting where the firmware image is verified:
concluding that the firmware image is trustworthy for use in updating operation of the hardware component.

13. The non-transitory machine-readable medium of claim 12, wherein storing the firmware image comprises:
providing, by the out of band component and via a sideband communication channel and based on the concluding that the firmware image is trustworthy, a copy of the firmware image to the storage component.

14. The non-transitory machine-readable medium of claim 12, wherein storing the firmware image further comprises:
selectively powering the storage component while other hardware components of the hardware resources are depowered.

15. The non-transitory machine-readable medium of claim 12, wherein the firmware image is stored in the storage component while a startup management entity is not operating.

16. A data processing system, comprising:
a processor; and
a memory coupled to the processor to store instructions, which when executed by the processor, cause the processor to perform operations for managing operation of a data processing system, the operations comprising:
making an identification of an occurrence of a firmware update event for a hardware component of hardware resources of the data processing system, the hardware resources being in-band components used in provisioning of desired computer implemented services;
based on the identification:
attempting to verify, using an out of band component of the data processing system, integrity of a firmware image for the hardware component;
in a first instance of the attempting where the firmware image is verified:
storing, by the out of band component, the firmware image in a boot partition of a storage component of the hardware resources, the boot partition being unusable by the in-band components;
initiating, by the out of band component, updating of the hardware component using the firmware image in the boot partition to obtain updated in-band components; and
provisioning the desired computer implemented services using the updated in-band components.

17. The data processing system of claim 16, wherein attempting to verify the integrity of the firmware image comprises:
obtaining, by the out of band component and via an out of band channel, integrity verification data for the firmware image from a trusted source;
attempting, by the out of band component, to cryptographically verify the firmware image using the integrity data; and
in an instance of the attempting where the firmware image is verified:
concluding that the firmware image is trustworthy for use in updating operation of the hardware component.

18. The data processing system of claim 17, wherein storing the firmware image comprises:
providing, by the out of band component and via a sideband communication channel and based on the concluding that the firmware image is trustworthy, a copy of the firmware image to the storage component.

19. The data processing system of claim 17, wherein storing the firmware image further comprises:
selectively powering the storage component while other hardware components of the hardware resources are depowered.

20. The data processing system of claim 17, wherein the firmware image is stored in the storage component while a startup management entity is not operating.
